(19) United States
(12) Patent Application Publication
(10) Pub. No.: US 2014/0306042 A1
(43) Pub. Date: Oct. 16, 2014

(54) Dry Food Waste Disposal System

(71) Applicant: Emerson Electric Co., St. Louis, MO (US)

(72) Inventors: Gregory J. CHESACK, Kenosha, WI (US); Jeffrey MCMAHON, Racine, WI (US)

(73) Assignee: Emerson Electric Co., St. Louis, MO (US)

(21) Appl. No.: 14/244,981

(22) Filed: Apr. 4, 2014

(30) Foreign Application Priority Data
Apr. 10, 2013 (IN) 1347MUM2013

(51) Int. Cl. B02C 25/00

(52) U.S. Cl. CPC B02C 25/00
USPC 241/36

(57) ABSTRACT

A dry food waste disposal system has a food waste disposer having a grind and discharge section having a grind mechanism having a stationary grind ring and a rotatable shredder plate rotated by a motor. The dry food waste disposal system also includes a storage tank that includes a sensor that senses how full the storage tank is, a discharge line coupling a discharge outlet of the food waste disposer to the storage tank, and a controller that disables the food waste disposer off in response to the sensor sensing that the storage tank is full.

### CROSS-REFERENCE TO RELATED APPLICATIONS

This application claims the benefit and priority of Indian Patent Application No. 1347MUM2013, filed Apr. 10, 2013. The entire disclosure of the above application is incorporated herein by reference. The United States Patent and Trademark Office is advised that Indian Patent Application No. 1347MUM2013 claims priority to U.S. Provisional Application No. 61/641347, filed May 2, 2012 (expired).

### FIELD

The present disclosure relates to disposal of organic food waste, and more particularly, to a dry food waste disposal system.

### BACKGROUND

This section provides background information related to the present disclosure which is not necessarily prior art.

Dry waste disposers that grind dry waste, such as organic food waste, medical waste, or other materials are known. For example, U.S. Pat. No. 5,340,036 discloses a dry waste grinder and U.S. Pat. No. 5,533,681 discloses a medical waste disposer.

It is also known to discharge ground food waste from a food waste disposer into a tank for storage. The tank is subsequently emptied and the ground food waste emptied from the tank is taken to a disposal site. Such a system is shown in U.S. Pat. No. 5,568,996.

A difficulty presented with the above described prior art is that the storage tank may be full yet the food waste disposer continues to be operated, and the user of the waste disposer may be unaware that the storage tank is full. This can result in clogging of the discharge line leading to the storage tank and may possibly result in the storage tank spilling over.

Another difficulty is that with a remotely located storage tank, it becomes more difficult to pass the comminuted food waste through the discharge line to the storage tank.

Another difficulty with dry food waste disposers is that the disposer may bog down under a heavy load of dry food waste.

### SUMMARY

This section provides a general summary of the disclosure, and is not a comprehensive disclosure of its full scope or all of its features.

A technical problem to be solved in accordance with an aspect of the present disclosure is to avoid operation of a dry waste disposer in a dry waste disposal system when a storage tank is full. Another technical problem to be solved is to alert a user when the storage tank is full or almost full. Another technical problem to be solved is to improve the flow of comminuted waste from the waste disposer to the storage tank.

In accordance with an aspect of the present disclosure, a dry food waste disposal system has a food waste disposer having a grind and discharge section having a grind mechanism having a stationary grind ring and a rotatable shredder plate rotated by a motor. The dry food waste disposal system also includes a storage tank that includes a sensor that senses how full the storage tank is, a discharge line coupling a discharge outlet of the food waste disposer to the storage tank, and a controller that disables the food waste disposer in response to the sensor sensing that the storage tank is full.

The dry food waste disposal system may also include a wireless communication module coupled to the controller via which the controller sends a wireless message to a recipient in response to the sensor sensing that the storage tank is full, almost full, or both.

The dry food waste disposal system may also include a storage tank full indicator energized by the controller in response to the sensor sensing that the storage tank is full and/or a storage tank almost full indicator energized by the controller in response to the sensor sensing that the storage tank is almost full.

The dry food waste disposal system may also include the controller, after disabling the food waste disposer in response to the sensor sensing that the storage tank is full, maintaining the food waste disposer disabled until the storage tank is emptied.

The storage tank may be remotely located from the food waste disposer.

The food waste disposer of the dry waste disposal system may include an upper food conveying section and a lower motor section with the grind and discharge section disposed therebetween. The upper food conveying section has a housing having a water inlet coupled to a water source by a solenoid valve that is energized by the controller in response to a sufficiently heavy load on the food waste disposer and introducing water into the upper food conveying section. The solenoid valve may be energized by the controller for a predetermined period of time.

The discharge line may have a diameter smaller than a diameter of an inlet opening of the discharge outlet of the food waste disposer. The discharge outlet of the food waste disposer may include a neck down fitting having an outer end to which the discharge line is coupled, the neck down fitting necking down from the inlet opening of the discharge outlet to the outer end of the neck down fitting.

The rotatable shredder plate of the food waste disposer may include a plurality of paddle elements extending downwardly into the discharge chamber that sweep a majority of the cross-sectional area of a discharge chamber of an upper end bell of the grind and discharge section as the rotatable shredder plate rotates.

### DRAWINGS

The drawings described herein are for illustrative purposes only of selected embodiments and not all possible implementations, and are not intended to limit the scope of the present disclosure.

FIG. 1 is a schematic of a food disposal system in accordance with an aspect of the present disclosure;

FIG. 2 is a cross-sectional view of a food waste disposer of the food waste disposal system of FIG. 1;

FIG. 3 is a bottom perspective view of an end bell and rotating shredder plate of the food waste disposer of FIG. 2;

FIG. 4 is a flow chart of a control program for controlling flow of water into the food waste disposer of FIG. 2; and

FIG. 5 is a flow chart of a control program for monitoring status of the food waste disposal system of FIG. 1, alerting and controlling the food waste disposer of FIG. 2.

Corresponding reference numerals indicate corresponding parts throughout the several views of the drawings.

### DETAILED DESCRIPTION

Example embodiments will now be described more fully with reference to the accompanying drawings.

In accordance with various aspects of the present disclosure, a food waste disposal system for comminuting organic food waste and discharging it into a storage tank where it is stored are described.

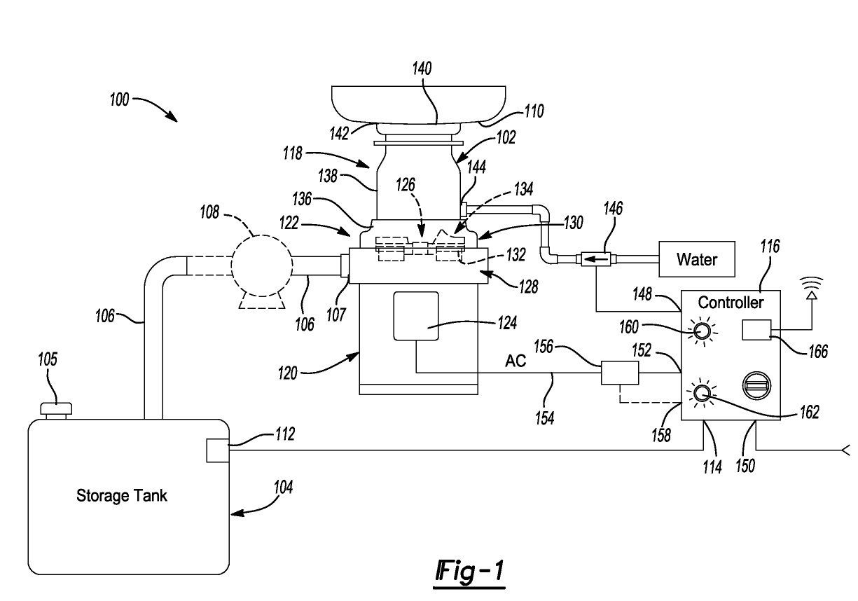

Referring to FIG. 1, a food waste disposal system 100 for comminuting organic food waste and discharging it into a storage tank where it is stored is shown. Food waste disposal system 100 is principally a dry food waste disposal system as described in more detail below. System 100 includes a food waste disposer 102, that is principally a dry waste food waste disposer as discussed in more detail below, and a storage tank 104. Storage tank 104 may include an access port 105 for accessing the interior of storage tank 104 to empty it, such as pumping it out. While access port 105 is shown in FIG. 1 in the top of storage tank 104, it should be understood that it could also be in a side of storage tank 104 or in a bottom of storage tank 104. A discharge line 106 couples a discharge outlet 107 of food waste disposer 102 to storage tank 104. A pump 108, shown in phantom in FIG. 1, may optionally be included at an appropriate point along discharge line 106, such as when storage tank 104 is located a long distance from food waste disposer 102 and/or elevated above food waste disposer 102. Food waste disposer 102 may illustratively be installed to a sink 110, such as may be found in a food processing facility such as a restaurant. Storage tank 104 includes a sensor 112 that senses how full storage tank 104 is, such as a level sensor. Sensor 112 is coupled to an input 114 of a controller 116 that controls system 100 as described in more detail below. It should be understood that if pump 108 is provided, it may be coupled to controller 116 and controlled by controller 116.

Food waste disposer 102 has an upper food conveying section 118, a lower motor section 120 and a grind and discharge section 122 disposed between the food conveying section 118 and the motor section 120. Motor section includes a motor 124. The grind and discharge section 122 includes a grind section 126 and a discharge section 128. The grind section 126 includes a grind mechanism 130. The grind mechanism 130 includes a stationary grind ring 132 and a rotatable shredder plate 134 that is rotated by motor 124. The grind section 126 includes a grind housing 136 that encompasses the grind mechanism 130. The grind ring 132 is mounted in a fixed (stationary) position within the grind housing 136, or may alternatively be formed as part of the grind housing 136.

The upper food conveying section 118 includes a housing 138 having with a waste inlet 140 at a top 142 thereof. Food waste is received within housing 138 of upper food conveying section 118 through waste inlet 140. Housing 138 of upper food conveying section 118 includes a water inlet 144 that is coupled to a source of water (not shown) via solenoid valve 146. Solenoid valve 146 is coupled to an output 148 of controller 116. It should be understood that sink 110 could have water inlet 144 instead of housing 138.

A source of AC (not shown) is coupled to a power input 150 of controller 116. A power output 152 of controller 116 is coupled to motor 124 via AC power cord 154. A load sensor 156, such as a current transformer around one of the wires of AC power cord 150, is coupled to an input 158 of controller 116.

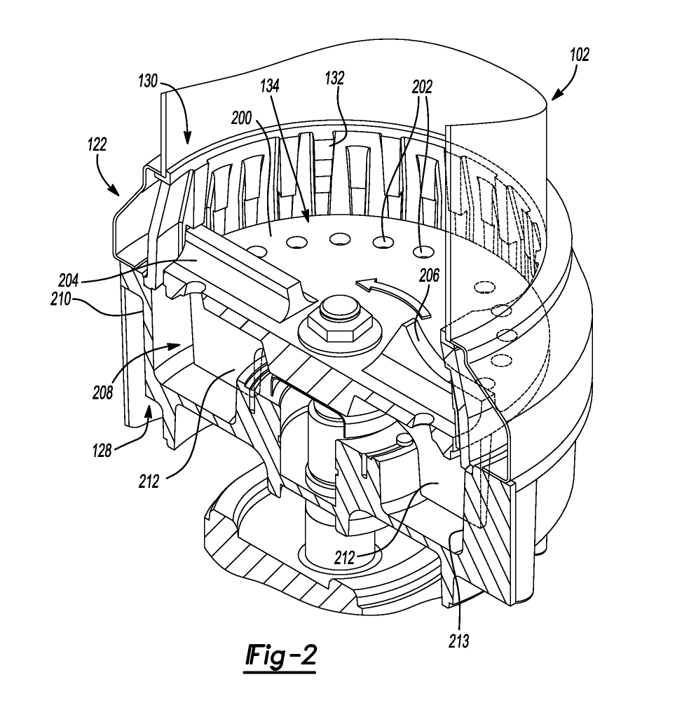

As best shown in FIG. 2, rotatable shredder plate 134 includes a flat plate portion 200 that may be provided with circular openings 202 around its perimeter. Rotatable shredder plate 134 also includes one or more lugs, such as lugs 204, 206, extending upwardly from flat plate portion 200. The lugs may have different shapes as required in order to cause particles of differing sizes or densities to be impelled by centrifugal forces as the rotating shredder plate 134 rotates. The lugs may be fixed lugs, swivel lugs, or a combination of fixed and swivel lugs. Circular openings 202 provide a means for additional air, as well as finely divided particles and/or water, to enter a discharge chamber 208 in an upper end bell 210 of discharge section 128 and eventually out the discharge outlet 107 (FIG. 1).

During operation, food waste from sink 110 is received into food conveying section 118 and then into the grind section 126. The rotatable shredder plate 134 is rotated by motor 124 to comminute the food waste into comminuted material. The comminuted material is passed from the grind section 126, such as through a gap between an outer periphery of rotatable shredder plate 134 and stationary grind ring 132, into discharge chamber 208 of discharge section 128, and eventually out the discharge outlet 107. The comminuted food waste is then conveyed through discharge line 106 to storage tank 104.

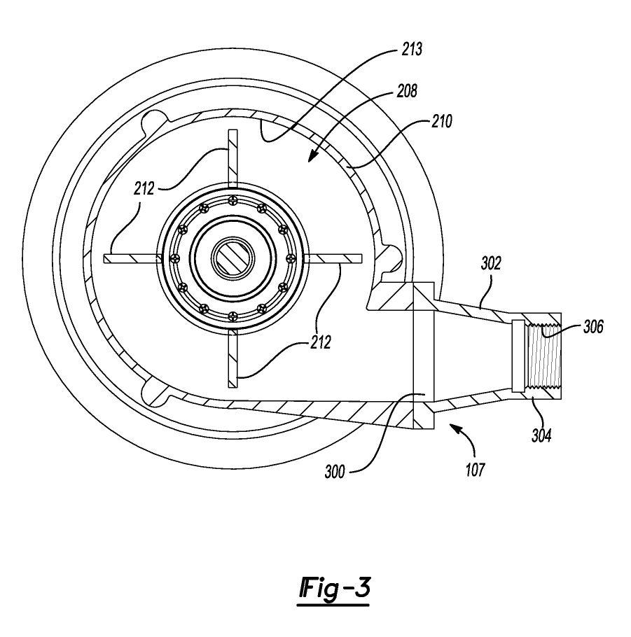

In order to provide a means to expel the comminuted food waste from the discharge chamber, rotating shredder plate 134 has a plurality of spaced paddle elements 212 extending downwardly into discharge chamber 208 with each spaced paddle element 212 extending across a majority of a cross-sectional area between a hub 211 of upper end bell 210 and an outer sidewall 213 of upper end bell 210 and thus across a majority of the cross-sectional area of the discharge chamber 208. Spaced paddle elements 212 sweep the majority of the cross-sectional area of discharge chamber 208 as rotatable shredder plate 134 rotates. As best shown in FIG. 3, discharge outlet 107 is located at one side of upper end bell 210 and thus one side of discharge chamber 208 providing a tangential discharge so that comminuted food waste is tangentially discharged from discharge chamber 208 through discharge outlet 107.

In an aspect as best shown in FIG. 3, discharge outlet 107 includes an inlet opening 300 in upper end bell 210 and a neck down fitting 302 extending from inlet opening 300 that necks down from inlet opening 300 to an outer end 304 of neck down fitting 302. That is, the internal diameter of neck down fitting decreases as it extends from inlet opening 300 to outer end 304. Discharge line 106 is attached to outer end 304 of neck down fitting 302 and outer end 304 may have a threaded portion 306 to facilitate the attachment of discharge line 106. Discharge line 106 has a smaller diameter than the diameter of inlet opening 300. Discharge line 106 may illustratively have the same diameter as the diameter of neck down fitting 302 at outer end 304. By way of example only and not of limitation, inlet opening 300 may have a three inch diameter and outer opening 304 of neck down fitting 302 may have a two inch diameter. The necking down at discharge outlet 107 results in paddle elements 212 providing a pumping action of the comminuted food waste as they are rotated around discharge chamber 208. Also, the necking down increases the velocity of the comminuted food waste as flows through neck down fitting 302 and into discharge line 106. The smaller diameter of discharge line 106 compared to inlet opening 300 results in discharge line 106 filling more quickly than if it had the same diameter as inlet opening 300 and also increases the velocity of the comminuted food waste flowing through discharge line 106. This results in a more efficient discharge of the comminuted food waste from food waste disposer 102 to storage tank 104.

As mentioned, food waste disposer 102 is principally a dry waste food waste disposer. Food waste disposer 102 is normally operated without introducing any water into it and the food waste is ground dry. That is, the only water is that which is in the food waste. In the event that the load on food waste disposer becomes sufficiently heavy, water is introduced into food waste disposer 102 through water inlet 144 to mix with the food waste, which reduces the load on food waste disposer 102. Controller 116 monitors the load on food waste disposer 102 as it is operating via load sensor 156. In the example embodiment shown in FIG. 1, as the load on the food waste disposer 102 increases, the current drawn by motor 124 also increases and upon determining that the current being drawn by motor 124 exceeds a first predetermined level, controller 116 energizes solenoid valve 146 to turn water on and introduce water into food waste disposer 102. In an aspect, water is introduced until the load on food waste disposer falls below a second predetermined level, which may be lower than the first predetermined level or the same as the first predetermined level. In an aspect, controller 116 introduces water into food waste disposer 102 for a predetermined period of time and then de-energizes solenoid valve.

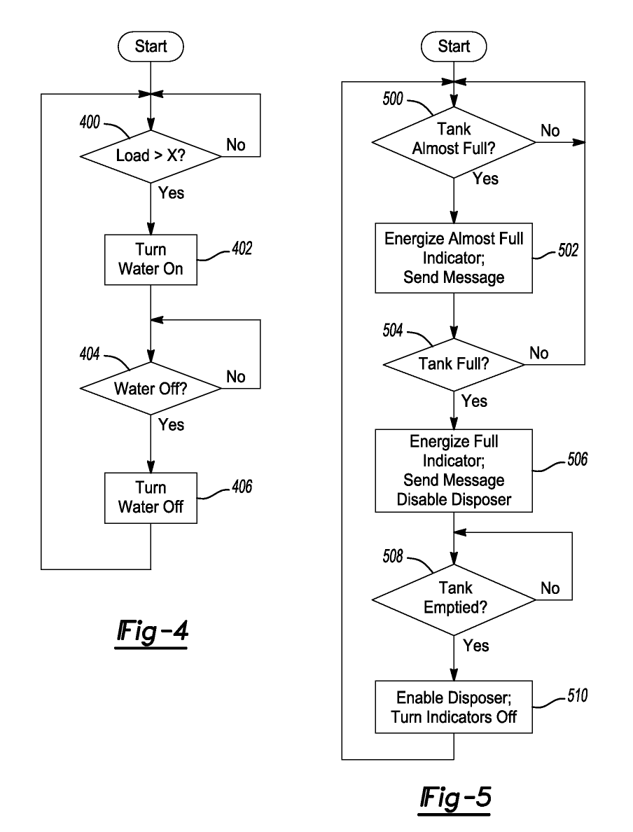

FIG. 4 is a simplified flow chart of control software implemented in controller 116 to control the introduction of water into food waste disposer 102 in accordance with the above. At 400, controller 116 checks whether the load on food waste disposer 102 has exceeded a first predetermined level. For example, when load sensor 156 is a current sensor, the first predetermined level would be current being drawn by motor 124 and controller 116 then checks the current being drawn by motor 124 to see if this current has exceeded the first predetermined level. If not, controller 116 branches back to 400. If the load on food waste disposer 102 has exceeded the first predetermined level, controller 116 proceeds to 402 where it turns the water on by energizing solenoid valve 146 and thus introducing water into food waste disposer 102. If the load on food waste disposer 102 has not exceeded the first predetermined level, controller 116 branches back to 400. After turning water on at 402, controller 116 checks at 404 whether to turn the water off. If water is to be turned off, controller turns the water off at 406 by de-energizing solenoid valve 146. It then branches back to 400.

In an aspect, controller 116 also monitors how full storage tank is via sensor 112. In an aspect, when storage tank 104 is almost full, controller 116 energizes a storage tank almost full indicator 160 to alert a user that the tank is almost full. In an aspect, controller 116 also disables food waste disposer 102 from operating when storage tank 104 is full and may also include a storage tank full indicator 162 that controller 116 energizes when the storage tank is full. Indicators 160, 162 are shown representatively as visual indicators on controller 116. It should be understood that it can be other than visual indicators, such as an audible indicator, and can be located other than on controller 116. For example, indicators 160, 162 can be located remotely from controller 116, such as on a wall next to sink 110, in an office of a manager of the facility in which food waste disposer 102 is used, or the other locations.

In an aspect, controller 116 includes a wireless communications module 166 which it may use to communicate status of various aspects of system 100 to one or more recipients. In an aspect, controller 116 sends wireless messages to the user when the storage tank is almost full and/or when it is full and it has disabled food waste disposer 102. In an aspect, controller 116 sends wireless messages to a company that empties the storage tank when the storage tank is almost full and/or when the storage tank is full and controller 116 has disabled food waste disposer 102.

FIG. 5 is a flow chart of control software implemented in controller 116 for the above discussed monitoring, alert and control functions. At 500, controller 116 determines whether storage tank 104 is almost full. If storage tank is not almost full, controller 116 branches back to 500. If storage tank 104 is almost full, at 502 controller 116 energizes storage tank almost full indicator 160 and sends a wireless message via wireless communications module 166 to one or more recipients. Controller 116 then proceeds to 504 where it determines whether storage tank 104 is full. If storage tank 104 is not full, controller 116 branches to 500. If storage tank 104 is full, at 506 controller 116 disables food waste disposer 102, energizes storage tank full indicator 162 and sends a wireless message via wireless communications module 166 to one or recipients. It should be understood that disabling food waste disposer 102 includes turning motor 124 off. Controller 116 maintains food waste disposer 102 disabled until storage tank 104 is emptied, or the system is otherwise reset. Controller 116 then enables food waste disposer 102 and turns indicators 160, 162 off.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A dry food waste disposal system, comprising:
a food waste disposer having a grind and discharge section having a grind mechanism having a stationary grind ring and a rotatable shredder plate rotated by a motor;
a storage tank that includes a sensor that senses how full the storage tank is;
a discharge line coupling a discharge outlet of the food waste disposer to the storage tank; and
a controller that disables the food waste disposer off in response to the sensor sensing that the storage tank is full.

2. The dry food waste disposal system of claim 1 including a wireless communication module coupled to the controller via which the controller sends a wireless message to a recipient in response to the sensor sensing that the storage tank is full, almost full, or both.

3. The dry food waste disposal system of claim 2 including one or both a storage tank full indicator or a storage tank almost full indicator wherein the storage tank full indicator is energized by the controller in response to the sensor sensing that the storage tank is full and the storage tank almost full indicator is energized by the controller in response to the sensor sensing that the storage tank is almost full.

4. The dry food waste disposal system of claim 1 wherein after disabling the food waste disposer in response to the sensor sensing that the storage tank is full, the controller maintains the food waste disposer disabled until the storage tank is emptied.

5. The dry food waste disposal system of claim 4 wherein the storage tank is located remotely from the food waste disposer.

6. The dry food waste disposal system of claim 1 wherein the storage tank is located remotely from the food waste disposer.

7. The dry food waste system disposal system of claim 1 wherein the food waste disposer includes an upper food conveying section and a lower motor section with the grind and discharge section disposed therebetween, the upper food conveying section having a housing having a water inlet coupled to a water source by a solenoid valve that is energized by the controller in response to a sufficiently heavy load on the food waste disposer and introducing water into the upper food conveying section.

8. The dry waste disposal system of claim 7 wherein the solenoid valve is energized by the controller for a predetermined period of time.

9. The dry food waste disposal system of claim 6, wherein the discharge line has a diameter smaller than a diameter of an inlet opening of the discharge outlet of the food waste disposer.

10. The dry waste disposal system of claim 9 wherein the discharge outlet of the food waste disposer includes a neck down fitting having an outer end to which the discharge line is coupled, the neck down fitting necking down from the inlet opening of the discharge outlet to the outer end of the neck down fitting.

11. The dry waste disposal system of claim 9 wherein the rotatable shredder plate includes a plurality of paddle elements extending downwardly into the discharge chamber that sweep a majority of the cross-sectional area of a discharge chamber of an upper end bell of the grind and discharge section as the rotatable shredder plate rotates.
